(19) United States
(12) Patent Application Publication
(10) Pub. No.: US 2007/0028504 A1
(43) Pub. Date: Feb. 8, 2007

(54) Rod holder

(76) Inventor: David Bruce Cameron, Brighton, MI (US)

Correspondence Address: HARNESS, DICKEY & PIERCE, P.L.C., P.O. BOX 828, BLOOMFIELD HILLS, MI, 48303, US

(21) Appl. No.: 11/198,940

(22) Filed: Aug. 5, 2005

(51) Int. Cl. A01K 97/10

(52) U.S. Cl. 43/21.2

(57) ABSTRACT

A rod holder connects to a boat and holds a fly rod, a spinning rod or a casting rod. The rod holder generally includes a base member having a connection portion that connects to the boat and a holder member that couples to the base member. The holder member has a first end including a first holder portion and a second end including a second holder portion. The first end is distal from the second end. The first holder portion includes a base and at least one wall connected to the base. A first dimension defines a distance between the first holder portion and the second holder portion. A second dimension defines a distance between the base and an edge of the at least one wall. The edge is distal from the base. A ratio of the first distance to the second distance is in a range from about 2 to 1 to about 24 to 1.

### FIELD

The present invention relates to a fishing rod holder and more particularly relates to a universal rod holder that may hold at least a fly rod, a casting rod or a spinning rod.

### BACKGROUND

There are many fishing rod configurations. In various rod and reel configurations, the length of the rod may vary as well as its diameter and flexibility. Furthermore, the position, configuration and orientation of the reel may change relative to the rod. With respect to a casting rod, for example, the reel may be spaced from the bottom of the rod a sufficient distance to permit a user to place one or two hands on the rod beneath the reel. A spinning rod and reel may be arranged so that the position of the reel may be similar to a casting reel but the spinning reel may be larger or closer to the spinning rod relative to the casting reel arrangement. With respect to a fly rod and reel, the reel may be positioned almost at the bottom of the fly rod, which may prevent the user from placing their hand(s) at the bottom of the fly rod. The fly reel may be even closer to the rod when compared to the casting or spinning rod and reel arrangement. Typically, a rod holder may only accept one of the above rod configurations. Multiple rod holders may be required or placement of the rod and reel in a rod holder that does not adequately secure the rod may be required.

### SUMMARY

The present teachings generally include a rod holder that connects to a boat and holds a fly rod, a spinning rod or a casting rod. The rod holder generally includes a base member having a connection portion that connects to the boat and a holder member that couples to the base member. The holder member has a first end including a first holder portion and a second end including a second holder portion. The first end is distal from the second end. The first holder portion includes a base and at least one wall connected to the base. A first dimension defines a distance between the first holder portion and the second holder portion. A second dimension defines a distance between the base and an edge of the at least one wall. The edge is distal from the base. A ratio of the first distance to the second distance is in a range from about 2 to 1 to about 24 to 1.

Further areas of applicability of the present teachings will become apparent from the detailed description and the appended claims provided hereinafter. It should be understood that the detailed description and specific examples are indicating the various embodiments of the present teachings are intended for purposes of illustration only and not intended to limit the scope of the teachings.

### BRIEF DESCRIPTION OF THE DRAWINGS

The present teachings will become more fully understood from the detailed description, the appended claims and the accompanying drawings, wherein:

FIG. 1 is a perspective view of the universal rod holder shown coupled to an exemplary kayak constructed in accordance with the present teachings;

FIG. 2 is an enlarged perspective view of the universal rod holder constructed in accordance with the present teachings;

FIG. 3 is similar to FIG. 2 and shows the rod holder in an exploded assembly view;

FIG. 4 is a top view of a first holder portion from FIG. 3 constructed in accordance with the present teachings;

FIG. 5 is a partial sectional view of the first holder portion from FIG. 4;

FIG. 6A is the rod holder of FIG. 2 holding a partial exemplary fly rod and reel;

FIG. 6B shows the rod holder of FIG. 2 holding a partial exemplary spinning rod; and

FIG. 6C shows the rod holder of FIG. 2 holding a partial exemplary casting rod and reel.

### DETAILED DESCRIPTION OF THE VARIOUS EMBODIMENTS

The following description of the various embodiments is merely exemplary in nature and is in no way intended to limit the present teachings, their application, or uses.

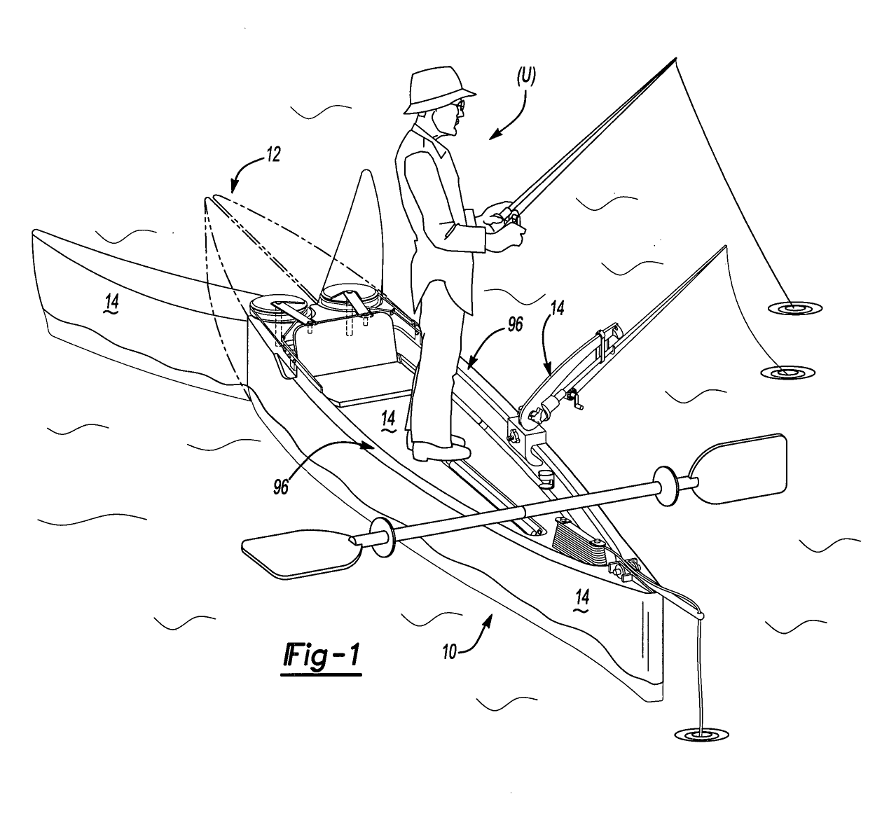

With reference to FIG. 1, the present invention generally includes a universal rod holder 10 that may be attached to a kayak 12. The rod holder 10 may be coupled to other crafts and portions thereof. In one example, the rod holder may be coupled to a canoe, a power boat, a sail boat, to stationary objects such as a dock or other suitable structures or combinations thereof. The kayak 12 may include various features and functions such as a deployable fan tail. The kayak 12, however, is outside the scope of the present disclosure but is disclosed in greater detail in United States Patent Application entitled Fishing Kayak with a Deployable Fan Tail, application Ser. No. ______, filed on ______ and referenced by attorney docket number 6197-000002, which is hereby incorporated by reference as if fully set forth herein.

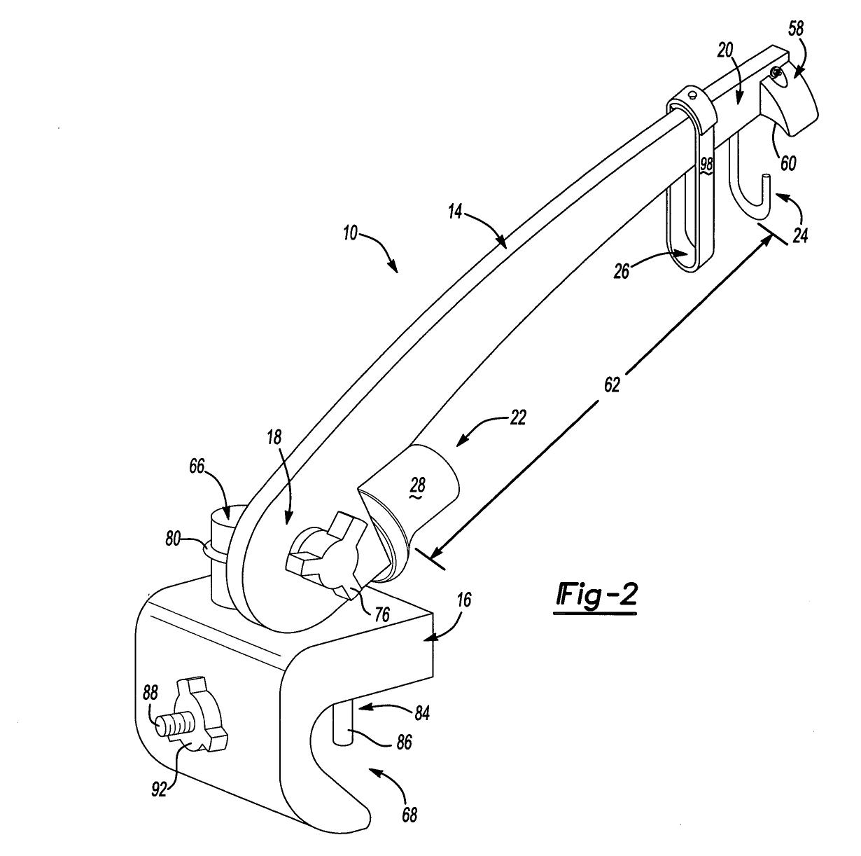

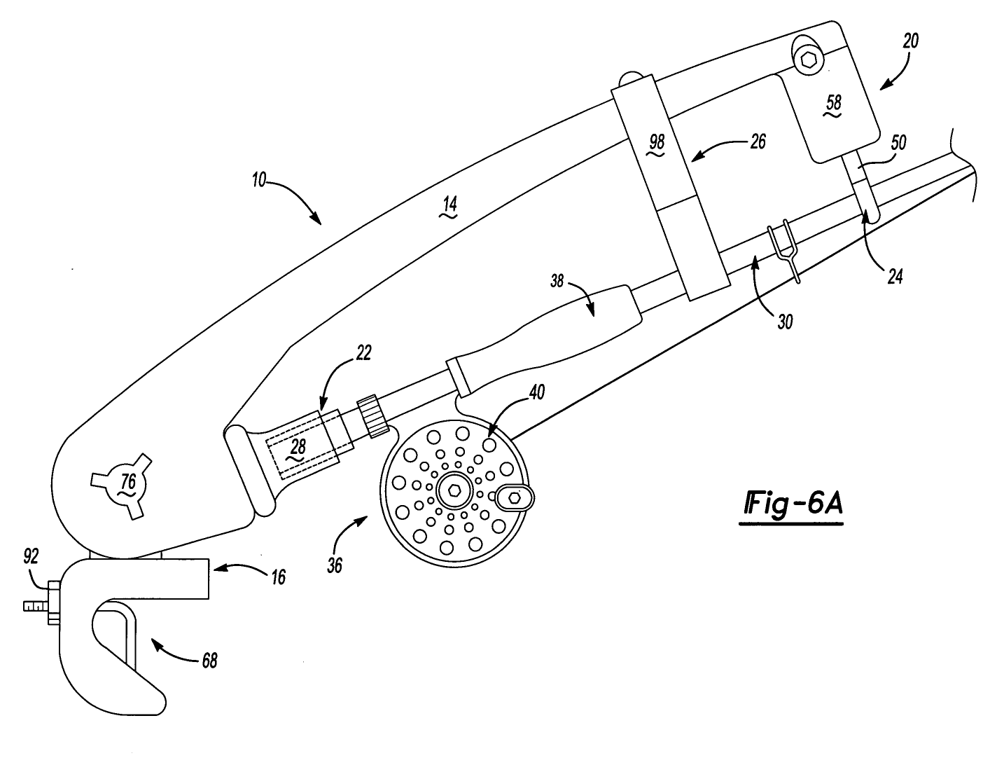

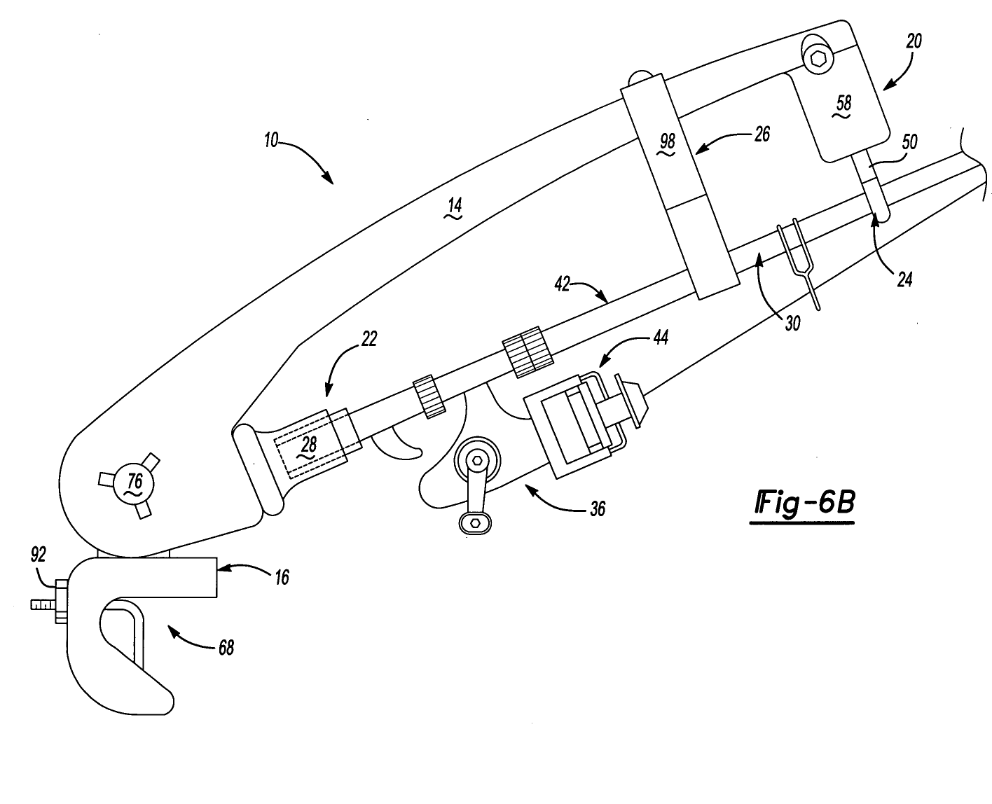

With reference to FIGS. 2-5, the rod holder 10 includes a holder member 14 and a base member 16. The holder member 14 has a first end 18 and a second end 20. The second end 20 is distal from the first end 18. The first end 18 may couple to the base member 16. The first end 18 may include a first holder portion 22. The second end 20 may include a second holder portion 24. The holder member 14 may also include a third holder portion 26.

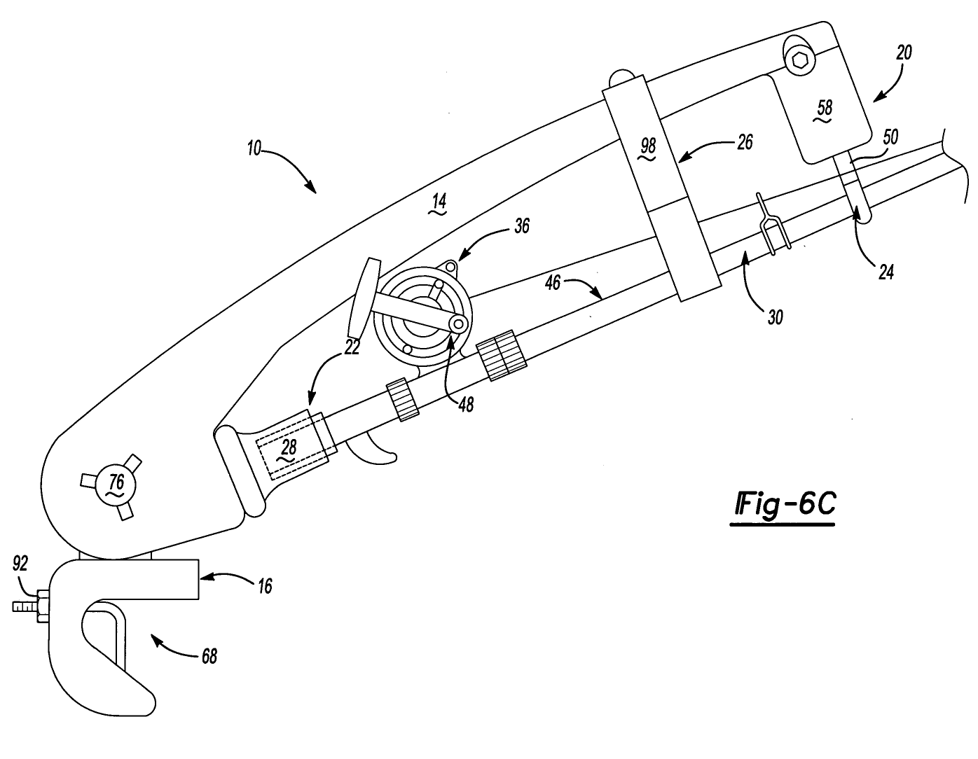

In one example, the first holder portion 22 may define a cup 28 that may extend from (coupled to or integral with) the first end 18 of the holder member 14. The cup 28 may receive and hold a fishing rod 30 and more specifically an end 30a (FIGS. 6A-6C) of the fishing rod 30. An inner diameter 32 (or a width as applicable) of the cup 28 is about 1.3 inches (about 33 millimeters). In one example, a depth 34 of the cup 28 may be about 1.5 inches (about 38 millimeters). The various configurations of the cup 28 permit the cup 28 to hold the end 30a of the fishing rod 30 without interfering (e.g., contacting and/or obstructing) with a reel 36, regardless of whether the rod 30 and the reel 36 are a fly rod 38 and a fly reel 40 (FIG. 6A), a spinning rod 42 and a spinning reel 44 (FIG. 6B) and/or a casting rod 46 and a casting reel 48 (FIG. 6C).

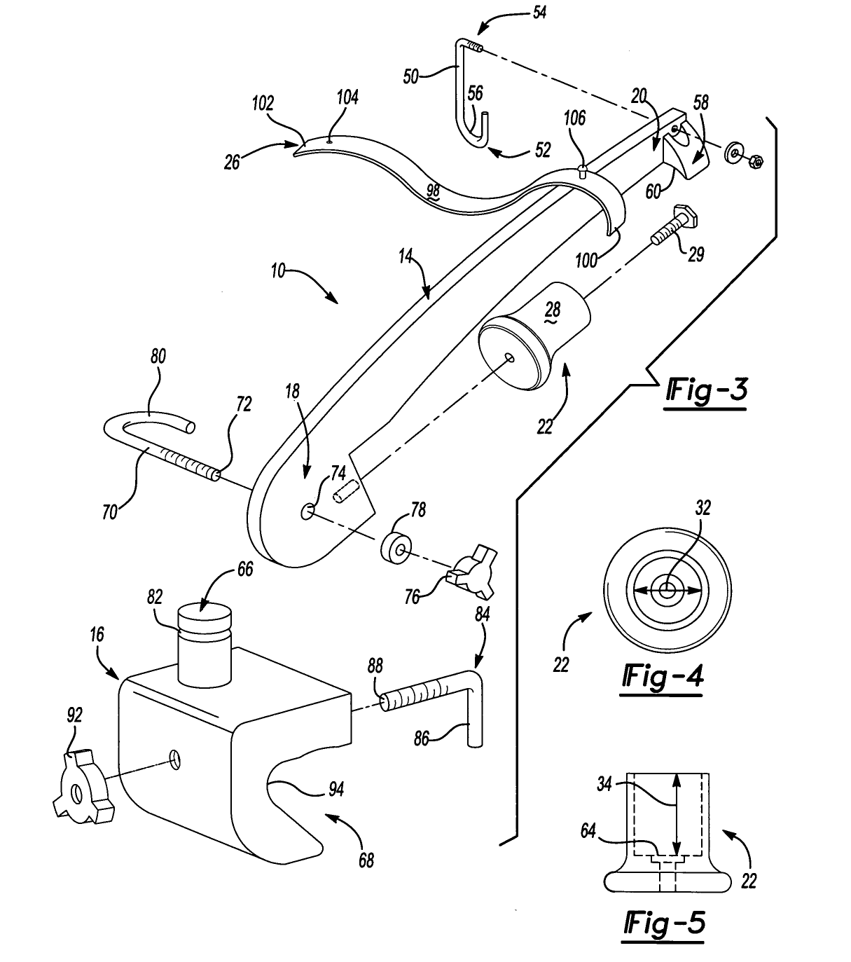

In one example and with reference to FIG. 3, the second holder portion 24 defines a hook 50. The hook 50 defines a rounded end 52 and a threaded end 54. The threaded end 54 may be coupled (releaseably or fixedly) to the second end 20 of the holder member 14. The rounded end 52 may have a curvature oriented such that an inside surface 56 of the curve is opposite the second end 20 of the holder member 14.

A curved protrusion 58 may extend from (integral with or coupled to) the second end 20. The curved protrusion may define a concave surface 60 such that the concave surface 60 is approximately opposed to the inside surface 56 of the curve of the second holder portion 24.

In one example, the rounded end 52 may be spaced from the second end 20 of the holder member 14 by about 1.5 inches (about 38 millimeters). The first holder portion 22 may be spaced from the second holder portion 24 and define a length 62 that is about 12 inches (about 305 millimeters). The length 62 may define a range of about 8 inches (about 203 millimeters) to about 16 inches (about 406 millimeters). The length 62 may define a distance between a base 64 of the cup 28 and the hook 50.

The base member 16 may define a post portion 66 and a clamp assembly 68. The holder member 14 may couple to the post portion 66. In one example, the holder member 14 may swivel about the post member 360° (or less). A fastener 70 with a threaded end 72 may be passed through an aperture 74 formed on the first end 18 of the holder member 14. A thumb wheel 76 and washer 78 may couple for rotation with the threaded end 72. Rotating the thumb wheel 76 may pull a curved portion 80 of the fastener 70 toward the first end 18 of the holder member 14. The curved portion 80 of the fastener 70 may capture the post portion 66 thus securing the holder member 14 to the base member 16. More specifically, the curved portion 80 of the fastener 70 may be received by an annular groove 82 formed in the post portion 66. In one example, the thumb wheel 76 may be loosened but not removed from the threaded end 72 thus allowing the holder member 14 to rotate more easily about the post portion 66, yet still remain connected thereto.

The clamp assembly 68 of the base member 16 may include a fastener 84 defining a bent or rounded end 86 and a threaded end 88. An aperture 90 formed in the base member 16 may receive the threaded end 88 of the fastener 70. A thumb wheel 92 may couple for rotation with the threaded end 88, which may be rotated to pull the bent portion 86 closer to the base member 16. Rotating the thumb wheel 92 therefore clamps whatever may be captured by the fastener 84 against a concave surface 94 defined by the base member 16. In one example, the base member 16 may be coupled to a gunwale 96 (FIG. 1) of a canoe or a kayak 10.

In another example, the base member 16 may be coupled to a rim of a sea kayak. In further examples, the base member 16 may attach to a safety rail or other portions of a power and/or sail boat. In yet other examples, the base member 16 may attach to a stationary platform such as a dock and/or a rail attached thereto. It will be appreciated that the base member 16 may be attached to whatever may be held by the clamping assembly 68. It will also be appreciated that the clamping assembly 68 and/or the base member 16 may be resized by the user or otherwise to fit over other structures as needed.

The third holding portion 26 of the holding member 14, in one example, may be a strap 98 that may be coupled on one end 100 to the holding member 14. The strap 98 may be looped around a rod 30 (e.g. rods 38, 42, 46) of any configuration and then have the other end 102 also couple to the holding member 14. Apertures 104 formed in the strap 98 may engage (i.e., releaseably lock to) a post 106 that extends from the holding member 14.

In one example and with reference to FIGS. 6A-6C, a user may insert a rod 30, 38, 42, 46 into the rod holder 10 for what would be intended as a relatively brief period. By way of the above example, use (or inclusion) of the third holding portion 26 may be optional. When the user intends to keep the rod 30 (e.g., rods 38, 42, 46) in the rod holder 10 relatively long period (e.g., transit in the water vehicle), the third holding portion 26 may be coupled around the rod 30 to further securing the rod 30 (e.g. rods 38, 42, 46) in the rod holder 10.

An angler or a user (U) (FIG. 1), which may be in (or around) the kayak 12, may use the rod holder 10 for various rod and reel combinations. Regardless of the rod and reel combination used, the combination can be held by the rod holder 10. With reference to FIG. 6A, a fly rod 38 and a fly reel 40 may be held on the rod holder 10. It will be appreciated that the fly reel 40 is relatively large compared to a spinning reel 44 shown in FIG. 6B. The fly reel 40 is positioned relatively closer to the fly rod 38 relative to the spinning rod 42 and reel 44. Also, the fly reel 40 is positioned relatively low on the fly rod 38 compared to the spinning rod and reel 42, 44.

In another example and with reference to FIG. 6B, the first holder portion 22 may accommodate the end of the spinning rod 42. In a further example and with reference to FIG. 6C, the first holder portion 22 can accommodate a casting rod and reel 46, 48. It will be appreciated that in any combination, the reel 40, 44, 48 may reside in various positions that may be between the rod 38, 42, 46 respectively and the holding member 14 or in other positions where the rod 38, 42, 46 is between the reel 36 (e.g., reels 40, 44, 48) and the holder member 14. Moreover, in any rod and reel configuration the first holder portion 22, the second holder portion 24 and/or the third holder portion 26 can accommodate rod and reel (e.g., as illustrated in FIGS. 6A-6C) combination regardless of the position of the reel 36 relative to the rod 30.

Those skilled in the art can now appreciate from the foregoing description that the broad teachings may be implemented in a variety of forms. Therefore, while the present teachings have been described in connection with particular examples thereof, the true scope of the present teachings should not be so limited because other modifications will become apparent to the practitioner upon a study of the drawings, the specification and the following claims.

What is claimed is:

1. A rod holder that connects to a boat and holds a fly rod, a spinning rod, or a casting rod, the rod holder comprising:
a base member having a connection portion that connects to the boat; and
a holder member coupled to said base member, said holder member having a first end including a first holder portion and a second end including a second holder portion, said first end distal from said second end, said first holder portion having a base and at least one wall connected to said base, wherein a first dimension defines a distance between said first holder portion and said second holder portion and a second dimension defines a distance between said base and an edge of said at least one wall, said edge distal from said base and wherein a ratio of said first distance to said second distance is in a range from about 2 to 1 to about 24 to 1.

2. The rod holder of claim 1 wherein said first dimension is in a range from about 6 inches (about 152 millimeters) to about 24 inches (about 609 millimeters) and said second dimension is in a range from about 1 inch (about twenty-five millimeters) to about 3 inches (about seventy-five millimeters).

3. The rod holder of claim 1 wherein said first dimension is about 12 inches (about 305 millimeters)

4. The rod holder of claim 1 wherein said second dimension is about 1.5 inches (about 38 millimeters).

5. The rod holder of claim 1 wherein said at least one wall defines a cavity in said first holder, said cavity receives an end of the fishing rod and said second holder portion holds the fishing rod at a location distal from the end.

6. The rod holder of claim 1 further comprising a post extending from said base member and a clamping member connected to said first end, said clamping member couples to said post of the base member and is adjustable between at least a fixed position and a moveable position, said holder member fixed relative to the base member in said fixed position and said holder member moveable relative said base member in said moveable position.

7. A fishing rod holder for holding a fishing rod and connecting to a structure, the fishing rod holder comprising:
a base member having a connection portion operable to attach to the structure; and
a holder member coupled to said base member, said holder member having a first end including a first holder portion and a second end including a second holder portion, said first end distal from said second end, said first holder portion having a base and at least one wall connected to said base, said base and said at least one wall defining a cavity in said first holder, said cavity receives an end of the fishing rod and said second holder portion holds the fishing rod at a location distal from the end.

8. The fishing rod holder of claim 7 wherein a first dimension defines a distance between said first holder portion and said second holder portion and a second dimension defines a distance between said base and an edge of said at least one wall, said edge distal from said base and wherein a ratio of said first distance to said second distance is in a range from about 2 to 1 to about 24 to 1.

9. The fishing rod holder of claim 8 wherein said first dimension is in a range from about 6 inches (about 152 millimeters) to about 24 inches (about 609 millimeters) and said second dimension is in a range from about 1 inch (about twenty-five millimeters) to about 3 inches (about seventy-five millimeters).

10. The fishing rod holder of claim 8 wherein said first dimension is about 12 inches (about 305 millimeters)

11. The fishing rod holder of claim 8 wherein said second dimension is about 1.5 inches (about 38 millimeters).

12. A fishing rod holder that holds a fishing rod and includes a base member having a post and a connection portion that couples to a structure, the fishing rod holder comprising:
a holder member having a first end and a second end distal from said first end;
a first holder portion coupled to said first end that holds an end of the fishing rod;
a second holder portion coupled to said second end that holds a portion of the fishing rod, the portion distal from the end; and
a clamping member connected to said first end, said clamping member couples to the post of the base member and is adjustable between at least a fixed position and a moveable position, said holder member fixed relative to the base member in said fixed position and said holder member moveable relative said base member in said moveable position.

13. The fishing rod holder of claim 12 wherein said first holder portion includes a base and at least one wall connected to said base, wherein a first dimension defines a distance between said first holder portion and said second holder portion and a second dimension defines a distance between said base and an edge of said at least one wall, said edge distal from said base and wherein a ratio of said first distance to said second distance is in a range from about 2 to 1 to about 24 to 1.

14. The fishing rod holder of claim 13 wherein said first dimension is in a range from about 6 inches (about 152 millimeters) to about 24 inches (about 609 millimeters) and said second dimension is in a range from about 1 inch (about twenty-five millimeters) to about 3 inches (about seventy-five millimeters).

15. The fishing rod holder of claim 13 wherein said first dimension is about 12 inches (about 305 millimeters)

16. The fishing rod holder of claim 13 wherein said second dimension is about 1.5 inches (about 38 millimeters).

17. The fishing rod holder of claim 12 wherein said at least one wall defines a cavity in said first holder, said cavity receives an end of the fishing rod and said second holder portion holds the fishing rod at a location distal from the end.
